(19) United States
(12) Patent Application Publication
(10) Pub. No.: US 2012/0046959 A1
(43) Pub. Date: Feb. 23, 2012

(54) Modeling Customer Behaviors

(75) Inventor: Mohit Nagrath, New Delhi (IN)

(73) Assignee: BANK OF AMERICA CORPORATION, Charlotte, NC (US)

(21) Appl. No.: 12/859,923

(22) Filed: Aug. 20, 2010

(51) Int. Cl. G06Q 10/00

(52) U.S. Cl. 705/1.1

(57) ABSTRACT

A computer system determines a model for a solicited offering based on selected variables that characterize a target population. A data set may be generated with a subset of variables from a set of variables. The set of variables may be representative of variables of data of customers associated with an entity, and the subset of variables may include at least 450 variables. A macro for determining a plurality of statistical characteristics about the subset of variables in the data set may be accessed, the plurality of statistical characteristics about the subset of variables in the data set may be determined based upon a number of observances of each respective variable of the subset of variables. A report of the determined plurality of statistical characteristics may be generated and outputted to a user device.

### BACKGROUND

Marketing can be a costly venture for businesses. Businesses often depend on direct advertising to potential customers to market different products or services. Direct mailings may be cost-effective, costing between 75 cents and $1 per mailing, including paper, ink, envelopes and postage. In some instances for a particular business, it may be effective, averaging between 1% and 3% response rate. It also may allow controlled growth enabling a business to choose how many mailings to send. If a business knows the average response rate, the business knows how many recipients will probably reply.

However, direct mailing advertising campaigns may be viewed as failure by a business when the response rate is significantly less than expected. Direct marketing groups in businesses assist various divisions of the business for effective targeting of customers by building models based upon acquired customer data and analyzing demographic and/or transactional data to understand the customer behavior. Improving the effectiveness of direct marketing often results in improved sales for a business while constraining the associated costs.

### SUMMARY

In light of the foregoing background, the following presents a simplified summary of the present disclosure in order to provide a basic understanding of some aspects of the present disclosure. This summary is not an extensive overview of the present disclosure. It is not intended to identify key or critical elements of the present disclosure or to delineate the scope of the present disclosure. The following summary merely presents some concepts of the present disclosure in a simplified form as a prelude to the more detailed description provided below.

Aspects of the present disclosure are directed to a method and system determining details of a data set under consideration for modeling customer behaviors. A computer system determines a model for a solicited offering based on selected variables that characterize a target population. A data set may be generated with a subset of variables from a set of variables. The set of variables may be representative of variables of data of customers associated with an entity, and the subset of variables may include at least 450 variables. A macro for determining a plurality of statistical characteristics about the subset of variables in the data set may be accessed, the plurality of statistical characteristics about the subset of variables in the data set may be determined based upon a number of observances of each respective variable of the subset of variables. A report of the determined plurality of statistical characteristics may be generated and outputted to a user device. The report may include fields preconfigured to identify the determined plurality of statistical characteristics per respective variable of the at least 450 variables.

In accordance with another aspect of the present disclosure, a variable may be added to the subset of variables in order to enhance the predicted response rate. Variables of the subset may be deleted from the subset if the statistical significance is not sufficient or ineffective.

Aspects of the present disclosure may be provided in a computer-readable medium having computer-executable instructions to perform one or more of the process steps described herein.

These and other aspects of the embodiments are discussed in greater detail throughout this disclosure, including the accompanying drawings.

### BRIEF DESCRIPTION OF THE DRAWINGS

A more complete understanding of aspects of the present disclosure and the advantages thereof may be acquired by referring to the following description in consideration of the accompanying drawings, in which like reference numbers indicate like features, and wherein:

FIG. 1 illustrates a schematic diagram of a general-purpose digital computing environment in which certain aspects of the present disclosure may be implemented;

FIG. 2 is an illustrative block diagram of workstations and servers that may be used to implement the processes and functions of certain embodiments of the present disclosure;

FIG. 3 shows a block diagram of a current process for getting details of variables of a data set.

FIG. 4 shows a block diagram of a process for getting details of variables of a data set in accordance with at least one aspect of the present disclosure.

FIGS. 5A-5B shows exemplary output results for a process that determines details of a data set in accordance with at least one aspect of the present disclosure.

### DETAILED DESCRIPTION

In the following description of the various embodiments, reference is made to the accompanying drawings, which form a part hereof, and in which is shown by way of illustration, various embodiments in which the disclosure may be practiced. It is to be understood that other embodiments may be utilized and structural and functional modifications may be made.

In accordance with various aspects of the present disclosure, methods, computer-readable media, and apparatuses are disclosed in which a model for a solicited offering (e.g., a direct advertisement mailing) is developed based on selected variables that characterize a target population of recipients. The model may be used to identify recipients in the target population in order to increase the expected probability of the recipients responding to the solicited offering. The model may be formed through an iterative process, in which at least a portion of the process is performed on a computer system.

For example, a business may desire to market a product, which may be tangible (e.g., an automobile) or intangible (e.g., a financial product), in a particular geographical area having many thousands of people. According to traditional systems, if the business were to send mailings to every household, the advertisement may be very expensive and not cost-effective. On the other hand, the business may randomly select households from the particular geographical area. Rather, according to one or more aspects of the present disclosure, customer/recipient variables of a data set of interest to the business may be processed to identify people to select from the geographical area.

According to an aspect of the present disclosure, a model initially may be formed using a subset of variables from characteristics of the target population. A performance process is then performed to assess the initial model, in which performance metrics are rendered for analysis. Based on the results of the analysis, the model may be modified so that the performance results may be enhanced and updated performance metrics may be analyzed. When desired results are obtained, the model may be finalized and final performance results may be rendered. The model may then be applied to a population of potential customers to identify recipients for a solicited offering.

In accordance with one or more aspects of the present disclosure, as described below, manual procedures are replaced with a statistical analysis system for generating model performance metrics with no manual touch points reducing model development time. Such a statistical analysis system as described herein may be an SAS® software macro. In accordance with one or more aspects of the present disclosure, such a macro may significantly reduce the number of steps for performance metrics report generation, and thus using the macro may significantly reduce development costs of the model.

Although not required, various aspects described herein may be embodied as a method, a data processing system, or as a computer-readable medium storing computer-executable instructions. For example, one or more computer-readable media storing instructions to cause one or more processor to perform steps of a method in accordance with aspects of the present disclosure is contemplated. For example, aspects of the method steps disclosed herein may be executed on one or more processors on a computing device 101. Such processors may execute computer-executable instructions stored on computer-readable media. The disclosure may also be practiced in distributed computing environments where tasks are performed by remote processing devices that are linked through a communications network. In a distributed computing environment, program modules may be located in both local and remote computer storage media including memory storage devices.

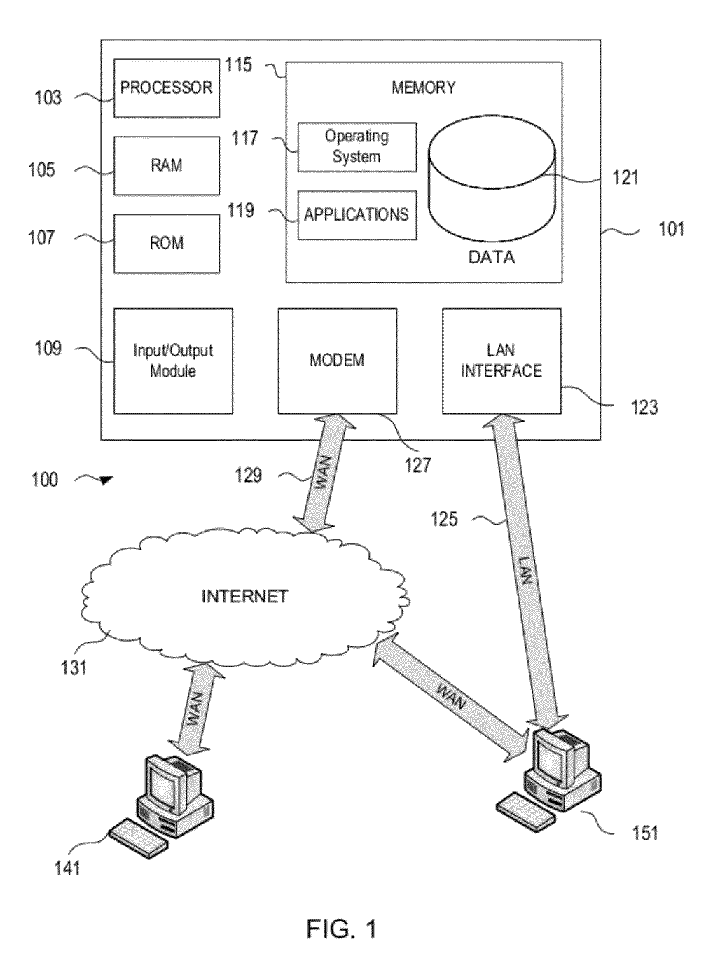

FIG. 1 illustrates a block diagram of a generic computing device 101 (e.g., a computer server) that may be used according to an illustrative embodiment of the disclosure. The computing device 101 may have a processor 103 for controlling overall operation of the server and its associated components, including RAM 105, ROM 107, input/output module 109, and memory 115.

Input/Output (I/O) 109 may include a microphone, keypad, touch screen, camera, and/or stylus through which a user of computing device 101 may provide input, and may also include one or more of a speaker for providing audio output and a video display device for providing textual, audiovisual and/or graphical output. Other I/O devices through which a user and/or other device may provide input to device 101 also may be included. Software may be stored within memory 115 and/or storage to provide instructions to processor 103 for enabling computing device 101 to perform various functions. For example, memory 115 may store software used by the computing device 101, such as an operating system 117, application programs 119, and an associated database 121. Alternatively, some or all of server 101 computer executable instructions may be embodied in hardware or firmware (not shown). As described in detail below, the database 121 may provide centralized storage of characteristics associated with individuals, allowing interoperability between different elements of the business residing at different physical locations.

The computing device 101 may operate in a networked environment supporting connections to one or more remote computers, such as terminals 141 and 151. The terminals 141 and 151 may be personal computers or servers that include many or all of the elements described above relative to the computing device 101. The network connections depicted in FIG. 1 include a local area network (LAN) 125 and a wide area network (WAN) 129, but may also include other networks. When used in a LAN networking environment, the computing device 101 is connected to the LAN 125 through a network interface or adapter 123. When used in a WAN networking environment, the computing device 101 may include a modem 127 or other means for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP and the like is presumed.

Computing device 101 and/or terminals 141 or 151 may also be mobile terminals including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

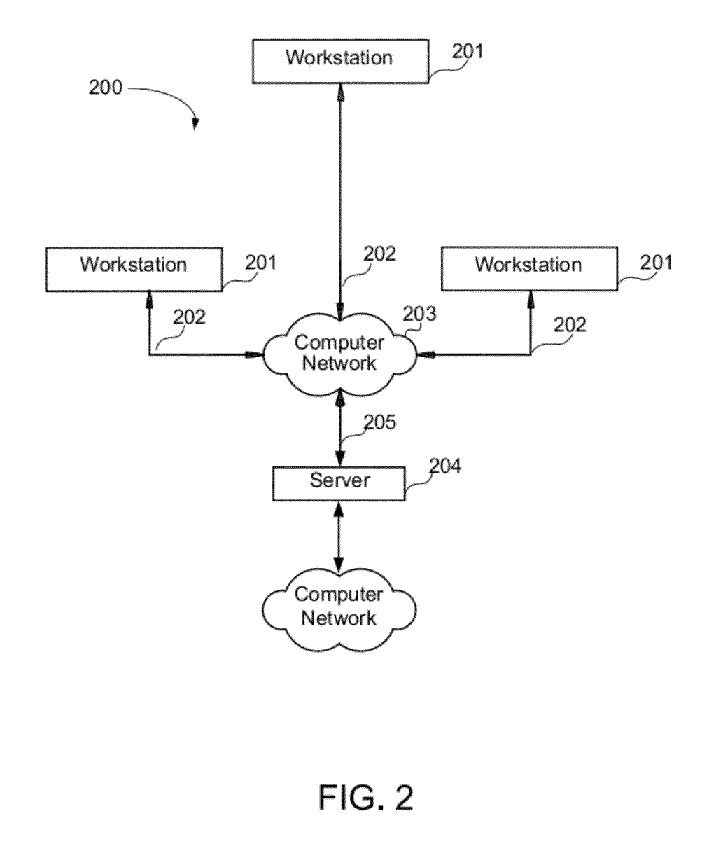

Referring to FIG. 2, an illustrative system 200 for implementing methods according to the present disclosure is shown. As illustrated, system 200 may include one or more workstations 201. Workstations 201 may be local or remote, and are connected by one or more communications links 202 to computer network 203 that is linked via communications links 205 to server 204. In system 200, server 204 may be any suitable server, processor, computer, or data processing device, or combination of the same.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, etc.

The steps that follow in the Figures may be implemented by one or more of the components in FIGS. 1 and 2 and/or other components, including other computing devices.

As part of a process for targeting potential customers to purchase a service/product, a business may desire to utilize data it has accumulated with respect tot current customers in order to target more effectively. The business may have lots of data it has accumulated with respect to various customers and may desire to utilize such data more effectively for targeting of products or services. Direct marketing groups of the business may assist by building models with respect to the accumulated data and may analyze demographic and/or transactional data to better understand customer behavior. When implementing such models, more data may be used to refine the model and take into account more variables of the data. However, such activities in utilizing more data create more human processing to complete. In effective processing of over 450 variables in a data set of a model, a human must write codes for every variable to process the data for use in targeting customers. Calculations such as a mean value or medium value of a variable, when taking into account hundreds, if not thousands, of occurrences of that variable, must be coded by a human individually. Such a current process of variables for a data set is both costly and time consuming.

A data set is a listing of data for a plurality of variables for processing and use in targeting customers to purchase products and/or services. The plurality of variables may be a subset of variables from a set of variables. The set of variables may be representative of variables of data of customers associated with an entity. A data set may be data used to determine how a customer or group of customers may react for purchasing purposes. A data set may include over 450 variables, but could include more or less. A variable may be any piece of identified data for consideration in targeting customers to purchase a product and/or service. For example, a variable may be data regarding a number of accounts that a customer has with the business. In the case of a financial entity as the business, a particular customer may have three different accounts: a savings account, a checking account, and a money market account. As such, a variable may exist for this data to be anywhere from a minimum values, such as one (1) account, to a maximum value, such as three (3) accounts.

The variable may be character based or numerical. For example, a variable may be a service level indicator code unique to the business. One example may be a car dealership. The dealership may maintain a service level indicator code associated with a particular customer. Such a service level indicator code may indicate how many vehicles this particular person has purchased through the dealership before. The dealership may have a service level indicator code of A for a customer who has purchased more than 2 vehicles from the dealership, a service level indicator code of B for a customer that has purchased 2 vehicles from the dealership, a service level indicator code of C for a customer that has purchased 1 vehicle from the dealership, and a service level indicator code of N (new) for a customer that has never purchased a vehicle from the dealership. Such data may be useful in targeting customers for products and/or services.

There may be any of a number of different types of variables associated with data maintained by a business. Other examples include an indication if a customer has a specific type of account, such as a retirement account, with the business; an indication of a total credit amount for a customer; an indication of a total credit quantity for a customer; an indication of a total debit amount for a customer; an indication of a total debit quantity for a customer; an indication of a total net interest income amount, for one or more accounts, for a customer; an indication of an oldest age of an account for a customer; an indication of whether a photo is associated with an account for a customer; an indication of a credit card cash advance amount for a customer; an indication of an overdraft protection plan for a customer; an indication of a total fees paid amount for a customer; an indication of a total debit card fee revenue for a customer; an indication of a student account for a customer; an indication of most frequented automated teller machine (ATM) for a customer; an indication of a number of teller deposits for a customer; and an indication of a number of ATM deposits for a customer. These variables, combinations of these variables, and any other number of additional types of variables may exist based upon data the business has accumulated and/or maintains about customers. As understood, variables may be proprietary to a business. The examples described herein are but illustrative examples and any variable may be designated based upon data accumulated and/or maintained by a business about customers.

In further describing variables, a variable may be binary data of a “1” or a “0.” Such a binary form of data may be used for logistic regression processing. Such data may equate to a yes or no answer. For example, a variable of current marital status may have an option of “1” for currently married or “0” for currently not married. In other examples, a variable may be linear data, i.e., any of a range of data. In the example of a variable for current money market account amount for a customer, such data may be any numeric value between $0 and a maximum allowable value, such as $100,000. Use of such data by a linear regression model may help target customers more effectively.

A data set may be used for a number of purposes beyond targeting customers for purchase of a product and/or service. Data in a data set may be used during the data exploration stage of any of a number of projects. For example, such data may be used for post program analysis, development of a model, ad-hoc analysis, identification and imputation of missing values, identification of outlier data, and treatment of outlier or missing value data. When utilizing a data set, processing of the variables often is needed. Procedures for implementing the processing of the variables are based upon a numerous number of snippets of code written by a human. Human input is required for writing the various codes for different types of information associated with the data set. These snippets of code provide details of the variables in the data set for further processing and/or use. A great time lag and cost are associated with the creation of these snippets of code.

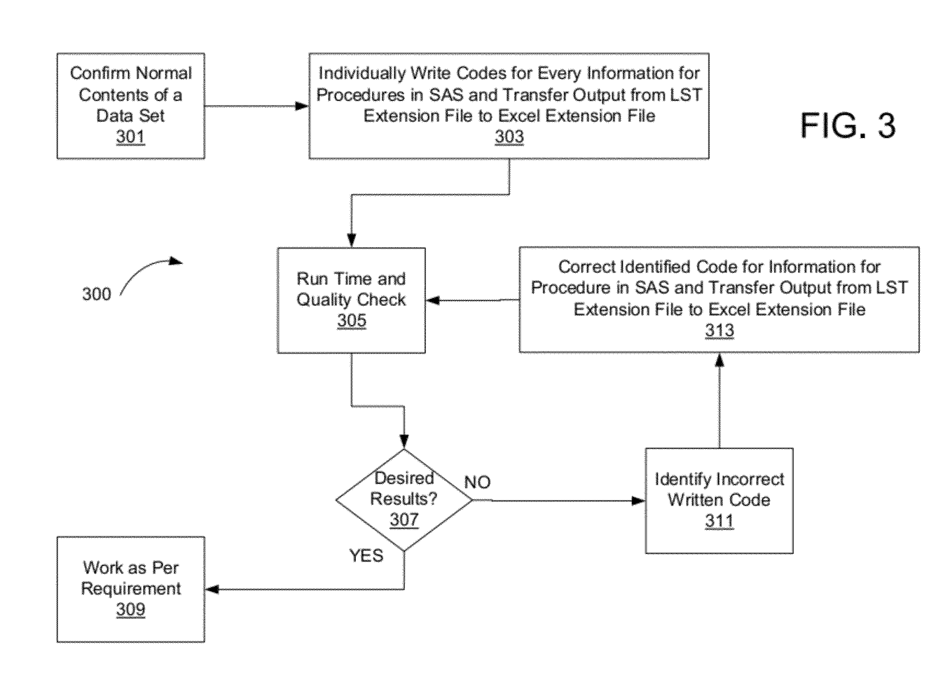

FIG. 3 shows a block diagram of a process 300 for getting details of variables of a data set. FIG. 3 illustrates the manual process for getting the details of the variables in a data set. At 301, a check may be performed to ensure the contents of a selected data set are included. Such a check may be a confirmation that data associated with all variables of the data set have been uploaded for processing. Contents of the selected data set may include the number of observations of the variables, e.g., the number of times the variable is being processed, such as 25000 for 25,000 different customers. Contents of the selected data set also may include the variables and other data.

Once confirmed in 301, the method proceeds to 303 where one or more people must individually write codes for every piece of needed information for procedures in SAS® language. These people must create numerous code snippets and procedures in SAS® language are one manner for doing so.
“Proc sort” is an SAS® language procedure for sorting data in ascending order. In order to have such a desired format for data, a code snippet must be written.
“Proc means” is an SAS® language procedure for producing descriptive statistics, such as means, standard deviation, minimum, maximum, etc., for numeric variables in a set of data.
“Proc univariate” is an SAS® language procedure for providing descriptive statistics as well. Although it is similar to “Proc means”, it is used in calculating a wider variety of statistics, specifically useful in examining the distribution of a variable.
“Proc transpose” is an SAS® language procedure for switching the significance of row and column identifiers, either globally or selectively.
“Proc freq” is an SAS® language procedure for providing descriptive statistics based upon the frequency of the variable. Data that are collected as counts require a specific kind of data analysis. Categorical data is analyzed by creating frequency and cross-tabulation tables. The primary procedure within SAS® for this kind of analysis is “Proc freq.”
“Proc print” is an SAS® language procedure to export data in an SAS® language format.

As noted above, one or more people must create numerous code snippets and procedures in SAS® language to create the necessary data for use in further processing. However, as noted, writing such code snippets requires a great deal of human intervention and requires generation of the code snippets for each separate statistical parameter requested, such as standard deviation, mean, medium, etc. With these code snippets all written for use, the process moves to 305.

In 305, run time and quality check are performed on the data set. In 307, a determination may be made as to whether the results from the quality check are the desired results. If not, the process moves to 311 where the incorrect written code must be identified. Such a step can take many hours and require a high cost. Once identified, the code must be corrected for information for procedures in SAS® language and then transfer the output from a LST extension file to an Excel, By Microsoft Corporation of Redmond, Wash., extension file in 313. Again, such a step in 313 requires more hours for correction and more money spent to do so. Once corrected in 313, the process returns back to 305 where run time and quality check are rerun for the data set. Once desired results are obtained in 307, the process moves to 309 where further work on or use of the data in the data set may be performed as required and/or needed. Such further processing may be in development of a model for targeting customers to purchase a product and/or service.

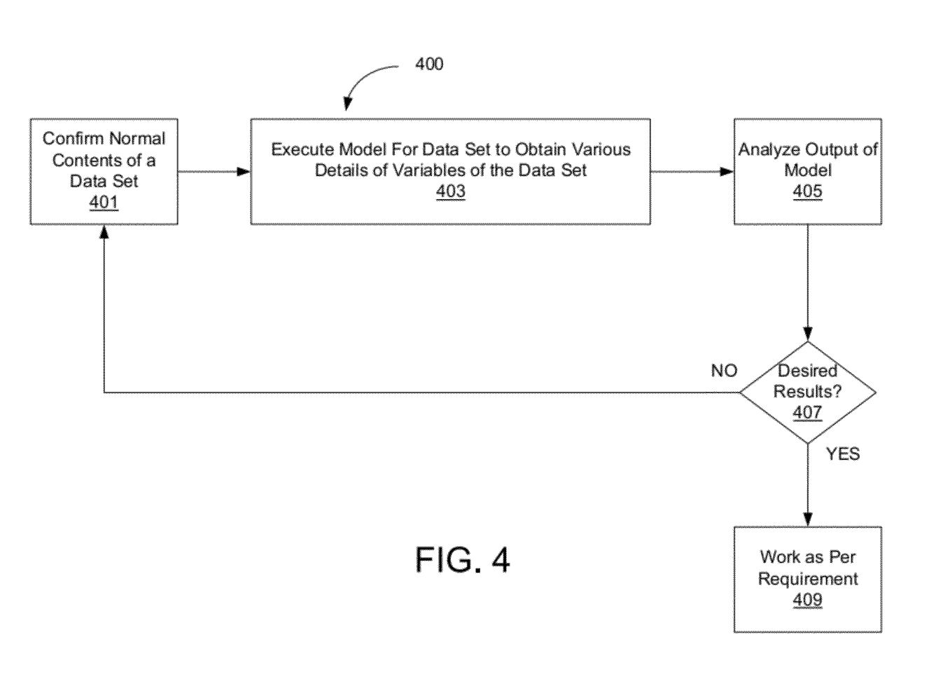

FIG. 4 shows block diagram of a process 400 in accordance with at least one aspect of the present disclosure. Marketing campaigns may be supported by developing models. The model may be used to target customers who are most likely to respond to a solicited offering. Development of a model by a computer system may require many logistic iterations (e.g., forty or fifty), and model performance metrics for the model may be checked for each iteration. According to traditional systems, each iteration may include a manual procedure for finalizing model estimates, where the corresponding manual activities often account for significant model development time.

At 401, a check may be performed to ensure the contents of a selected data set are included. Such a check may be a confirmation that data associated with all variables of the data set have been uploaded for processing. Contents of the selected data set may include the number of observations of the variables, e.g., the number of times the variable is being processed, such as 25000 for 25,000 different customers. Contents of the selected data set also may include the variables and other data. The subset of variables under consideration in a data set may be 450 variable or more.

Once confirmed in 401, the method proceeds to 403. In 403, a macro for a statistical analysis system may be implemented in accordance with at least one aspect of the present disclosure. The macro for a statistical analysis system may obtain various details of variables of the data set. As opposed to the numerous human written snippets of code for various procedures in SAS® language in 303 of FIG. 3, a single macro may be implemented in 403 in order to produce statistical outputs for further use and/or processing in order to determine customer behavior and target customers for products and/or services. The statistical outputs may be generated in a user interface format and/or spreadsheet format for ease of a user in working with the resulting statistical data for further processing.

Process 403 may be implemented as a SAS® language macro for generating model metrics with no manual touch points reducing model development time. The macro may significantly reduce the number of steps for metrics report generation, and thus using the macro may significantly reduce development costs of the model. An illustrative example of an SAS® language macro for performing the process of 403 is illustrated below.

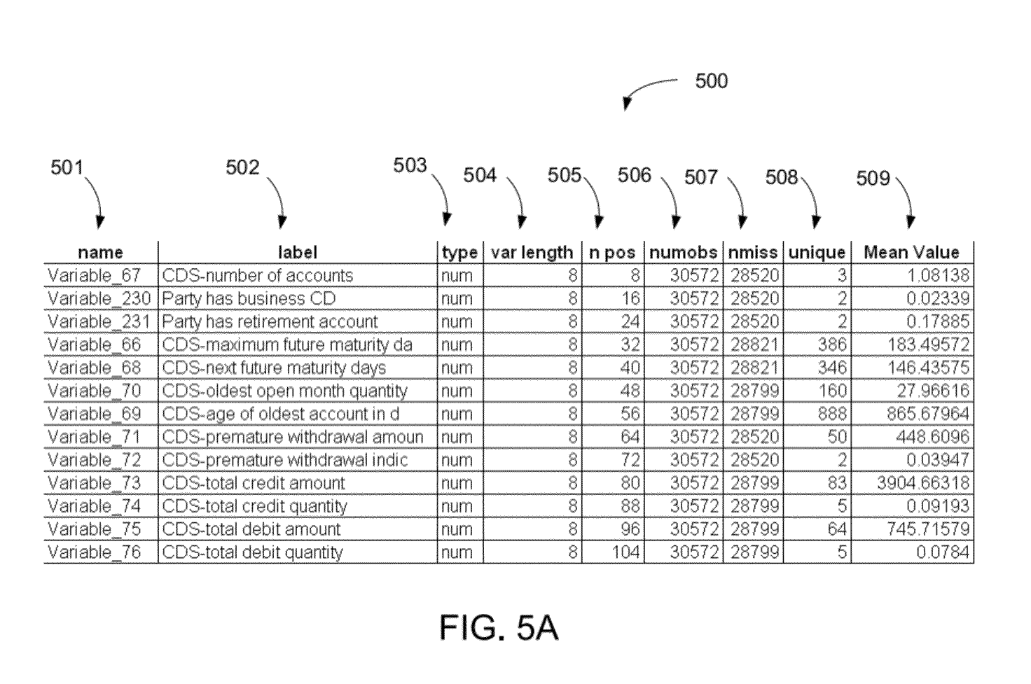

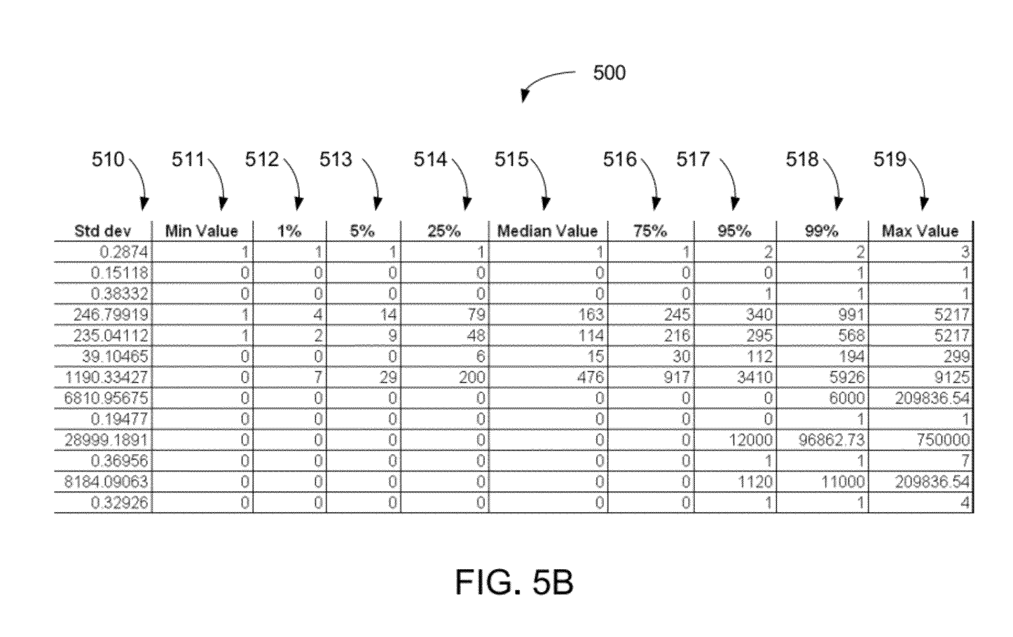

The statistical outputs of process 403, shown illustratively in FIGS. 5A and 5B and described in more detail below, is an illustrative output of details of the data set under consideration for a plurality of variables. Illustrative details include the variable type, such as numeric or character, the length of data bits of the variable, such as 8 bits, the number of observations of the variable being considered in the data set, such as 25,000 observances, non missing values of a variable, e.g., the number of instances of the variable not missing a value, unique values under consideration, mean of a variable, standard deviation of a variable, a minimum value of a variable, a maximum value of a variable, and various percentile values of a variable. Additional illustrative examples are included below and other statistical parameters of a variable may be included.

In 405, the output of the macro processing in 403 may be analyzed for any of a number of reasons. In one example, the processed data in the data set may be quickly viewed to find all variables with a small number of non missing values, i.e., a large number of occurrences of the variable have no value for the variable. Any of a number of reasons may exist as to why there are missing values. For example, if the variable is associated with online banking, a customer included as an occurrence of the variable may not participate in online banking at all. As such, data associated with that customer and the respective occurrence of the variable, may be missing. Such data may be taken into account in further processing as a baseline or they may not be taken into account at all.

The process moves to 407 where a determination may be made as to whether the analyzed results are the desired results. If not, the process may return to 401 where data of the data set may be corrected before inclusion in the data set. Once desired results are obtained in 407, the process moves to 409 where further work on or use of the data in the data set may be performed as required and/or needed. Such further processing may be in development of a model for targeting customers to purchase a product and/or service.

FIGS. 5A and 5B show output results 500 for process 403 that obtains various details of variables of the data set in accordance with at least one aspect of the present disclosure. The illustrative statistical output results shown in FIGS. 5A and 5B include:
Variable Name 501: This column identifies the variables under consideration in the data set. As previously noted, this column can include hundreds of variables for processing at one time, as opposed to individual processing.
Variable Label 502: This column identifies a label associated with the Variable Name 501. As the Variable Name 501 may be a code, this column may allow a user to quickly determine the basis of the variable. For example, in the first row, the Variable Label 502 is “CDS-number of accounts.” This variable label may be known by the user as the number of accounts a customer has with the business in question.
Type 503: This column identifies whether the data in question is numeric or character based.
Variable Length 504: This column identifies the length of the data in bits for storage of an associated value. In each example in 504, the number of bits is 8 bits for the variable length. However, fewer or more bits may be utilized.
N Position 505: This column identifies the position of the associated bits of data for the variable with respect to the first bit of the data set. As shown in this example, column 505 has been sorted from a stating bit of the data set in a descending order.
Number of Observances 506: This column the number of occurrences of the variable that are under consideration. For example, in the first row, the Variable Label 502 “CDS-number of accounts” has a Number of Observances 506 of 30572. That correlates to 30572 observances of the variable are being considered as part of the data set, e.g., a pool of 30572 observances are being processed for statistical outputs. These 30572 observances may relate to 30572 different customers or fewer than 30572 customers.
Non Missing Values 507: This column identifies the number of non missing values for the variable in relation to the corresponding Number of Observances 506 of the variable. This column of data may be helpful in quickly identifier variables where little data is being accounted for. In further processing of the data, the information of the non missing values may be utilized to remove the variable entirely or modify the results when performing the further processing. For example, the data that have values may be utilized while observances of the variable with data missing may be dropped from the further processing.
Unique Values 508: This column identifies the number of unique entries of the corresponding Number of Observances 506. For example, in the first row, the Variable Label 502 “CDS-number of accounts” has a Unique Values 508 value of 3. This means that of the 28,520 non missing values of the number of observances of the variable, there are only three different values. In the example of FIGS. 5A and 5B, these are 1, 2, or 3 to correlate to 1 account, 2 accounts, or 3 accounts.
Mean Value 509: This column identifies the statistical mean value of the variable.
Standard Deviation 510: This column identifies the statistical standard deviation value of the variable.
Minimum Value 511: This column identifies the minimum value for the variable of the 30572 observances of the variable, not including the observances with a missing value.
Value for the 1% Percentile 512: This column identifies the value of the observations of the variable at the lowest 1% of the scale from minimum to maximum value.
Value for the 5% Percentile 513: This column identifies the value of the observations of the variable at the lowest 5% of the scale from minimum to maximum value.
Value for the 25% Percentile 514: This column identifies the value of the observations of the variable at the lowest 25% of the scale from minimum to maximum value.
Median Value 515: This column identifies the statistical median value for the variable of the 30572 observances of the variable, not including the observances with a missing value.
Value for the 75% Percentile 516: This column identifies the value of the observations of the variable at the highest 25% of the scale from minimum to maximum value.
Value for the 95% Percentile 517: This column identifies the value of the observations of the variable at the highest 5% of the scale from minimum to maximum value.
Value for the 99% Percentile 518: This column identifies the value of the observations of the variable at the highest 1% of the scale from minimum to maximum value.
Maximum Value 519: This column identifies the maximum value for the variable of the 30572 observances of the variable, not including the observances with a missing value.

Returning to FIG. 4 with respect to the example of FIGS. 5A and 5B, process 401 may include defining the data set for statistical analysis and including the variables of the data set. Process 401 may include the loading of the data of the Variable Name 501 and Variable Label 502. The data of the data set may be loaded from a plurality of different physical memory locations where the corresponding data is maintained. Data for a business may be stored in different geographic locations in different physical memories. As such, as part of the process of defining the data set for analysis and variables for processing, the system may in 401 pull the data from various different locations. Once loaded and identified, the process may proceed to 403 where statistical analysis of the variables of the data are performed in accordance with the present disclosure.

Process 403 performs the computations on the variables included in the analysis to generate the various columns 503-519 in FIGS. 5A and 5B. Process 403 may be a dedicated computing device, such as a server within a network, specifically configured to perform the operations described herein. A user of the process 400 may be operating a remote computing device. The user may access the macro of the process 403 from a remote computing device. The macro of process 403 may be maintained at a centralized server and any user having access to the centralized server may access the macro for use.

Process 403 may be an SAS® language macro configured to determine one or more of the Type 503, the Variable Length 504, the N Position 505, the Number of Observances 506, the Non Missing Values 507, the Unique Values 508, the Mean Value 509, the Standard Deviation 510, the Minimum Value 511, the Value for the 1% Percentile 512, the Value for the 5% Percentile 513, the Value for the 25% Percentile 514, the Median Value 515, the Value for the 75% Percentile 516, the Value for the 95% Percentile 517, the Value for the 99% Percentile 518, and the Maximum Value 519.

Type 503 may be determined based upon the format of the value of the variable. Accordingly, the macro may assign a code of “num” for numeric or “char” for character based. Variable Length 504 may be determined based upon the input data of the variable in observance. The macro may assign a numeric value representative of the number of bits of data for that variable. N Position 505 may be determined based upon the data of the variable with respect to a first bit of the data set. The macro may assign the position of the data from such a starting bit of data.

Number of Observances 506 may be determined based upon the input to the data set. Prior to processing of the data by the macro, the system may have confirmed the number of observances, such as in process 401 in FIG. 4. Non Missing Values 507 may be determined based upon analyzing the number of observances of the variable to find the total number where a value has been entered for the variable in question. The macro may determine the non missing value for a variable by subtracting the number of missing values for a variable from the number of observances of the variable. Unique Values 508 may be determined by noting the number of different values of a variable in the number of observances. This macro may determine this value by excluding missing values or may also note a missing value as a unique value for the variable. As such, this value will never exceed the number of observances of the variable.

Mean Value 509 may be determined by calculating the average of the variable values for a variable. If there are 10,000 variable observances, with varying values between 0 and 100, the macro may determine the mean as the average of the values for the 10,000 variable observances. Standard Deviation 510 may be determined by calculating the standard deviation of the number of observances of the variable. The macro may round the value of the standard deviation to a certain decimal place.

Minimum Value 511 may be determined by analyzing the values of the number of observances and determining the least, i.e., minimum value of the values of the number of observances of the variable. The macro may compare a first value with a second value, determine the lesser value of the two, and then subsequently compare that lesser value to the next value of the variable in the list of values of the number of observances. That process of comparing may continue for the remainder of the values of the variable for the number of observances. The macro is then left with the minimum value of all of the values of the observances. Other manners of determining the minimum value also may be performed. Value for the 1% Percentile 512 may be determined by averaging the values of the lowest 1% values of the number of observances of the variable. The macro may be configured to determine this value for the 1% percentile. Value for the 5% Percentile 513 may be determined by averaging the values of the lowest 5% values of the number of observances of the variable. The macro may be configured to determine this value for the 5% percentile. Value for the 25% Percentile 514 may be determined by averaging the values of the lowest 25% values of the number of observances of the variable. The macro may be configured to determine this value for the 25% percentile.

Median Value 515 may be determined by calculating the middle value of the variable values for a variable. If there are an odd number of variable observances, such as 455, the macro may determine the median value as the middle value of the values for the 455 variable observances. The macro may arrange the order of the values from lowest to highest for all 455 observances. Then, the middle value of those ordered 455 values, the value of number 228 in the ordered 455 values, is the median value. If there is an even number of variable observances, such as 450, the macro may determine the median value as the middle pair values of the values for the 450 variable observances. The macro may arrange the order of the values from lowest to highest for all 450 observances. Then, the middle pair values of those ordered 450 values, the values of numbers 225 and 226 in the ordered 450 values, are averaged to arrive at the median value for the 450 observances of the variable.

Value for the 75% Percentile 516 may be determined by averaging the values of the highest 25% values of the number of observances of the variable. The macro may be configured to determine this value for the 75% percentile. Value for the 95% Percentile 517 may be determined by averaging the values of the highest 5% values of the number of observances of the variable. The macro may be configured to determine this value for the 95% percentile. Value for the 99% Percentile 518 may be determined by averaging the values of the highest 1% values of the number of observances of the variable. The macro may be configured to determine this value for the 99% percentile.

Maximum Value 519 may be determined by analyzing the values of the number of observances and determining the most, i.e., maximum value of the values of the number of observances of the variable. The macro may compare a first value with a second value, determine the greater value of the two, and then subsequently compare that greater value to the next value of the variable in the list of values of the number of observances. That process of comparing may continue for the remainder of the values of the variable for the number of observances. The macro is then left with the maximum value of all of the values of the observances. Other manners of determining the maximum value also may be performed.

A variable may be deleted from the model if the variable is sufficiently statistically insignificant or ineffective to the determination of statistical outputs of a variable for further processing in targeting customers. Statistically insignificant variables typically do not enhance the performance metrics. Statistically insignificant variables are not typically included in the model. In addition, variables may be added so that the model includes all of the significant variables with a high targeting rate. The model may include less significant variables under a permissible significance limit.

The below listing shows an illustrative computer program listing of an SAS® language process for detailing variables of a data set in accordance with at least one aspect of the present disclosure. As should be understood, the present disclosure is not limited to implementation of an SAS® language macro but other statistical analysis systems may be utilized in accordance with one or more aspects of the present disclosure provided herein. The following SAS language macro is one illustrative example of such a process and the present disclosure is not limited to the one example.

Initially, generally understand labels for the SAS® language macro are needed for implementation. These labels may include:

Indata = an SAS ® input data set
Libin = a Library Name for input data set, the Library Name is changed
accordingly to the input data set
VSE_out_loc_xls = Specifies path for saving output of VSE. VSE
outputs are saved in the form of *.html file and *.xls file.
Libout = Specifies a Library Name for saving output of VSE-GEN-2 in the
form of SAS ® data set. unique_num = Option for displaying number of
unique values for numeric variable.

unique_num = Y will calculate number of unique values for numeric
variable.
unique_num = N will not calculate number of unique values for
numeric variable.

outdata = Name of the final dataset

The below SAS® language macro illustrates one manner for detailing variables of a data set in accordance with at least one aspect of the present disclosure.

Aspects of the embodiments have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the embodiments. They may determine that the requirements should be applied to third party service providers (e.g., those that maintain records on behalf of the company).

What is claimed is:

1. A method comprising:
generating a data set with a subset of variables from a set of variables, the set of variables representative of variables of data of customers associated with an entity, the subset of variables including at least 450 variables;
accessing, by a computer system, a macro for determining a plurality of statistical characteristics about the subset of variables in the data set;
determining, by the computer system, the plurality of statistical characteristics about the subset of variables in the data set based upon a number of observances of each respective variable of the subset of variables;
generating a report of the determined plurality of statistical characteristics, the report including fields preconfigured to identify the determined plurality of statistical characteristics per respective variable of the at least 450 variables; and
outputting the report to a user device.

2. The method of claim 1, wherein generating the data set with the subset of variables from the set of variables includes loading data of the subset of variables.

3. The method of claim 1, wherein the accessing, by the computer system, the macro includes accessing a centralized server maintaining the macro.

4. The method of claim 1, wherein the determining, by the computer system, the plurality of statistical characteristics about the subset of variables in the data set based upon the number of observances of each respective variable of the subset of variables includes:
determining a mean value of each respective variable;
determining a standard deviation of each respective variable;
determining a minimum value of each respective variable;
determining a median value of each respective variable; and
determining a maximum value of each respective variable.

5. The method of claim 4, the generating the report of the determined plurality of statistical characteristics including:
generating a first column identifying each respective variable;
generating a second column identifying the mean value of each respective variable;
generating a third column identifying the standard deviation of each respective variable;
generating a fourth column identifying the minimum value of each respective variable;
generating a fifth column identifying the median value of each respective variable; and
generating a sixth column identifying the maximum value of each respective variable.

6. The method of claim 5, wherein only non missing values of variables of the subset of variables are utilized for determining the mean value, the standard deviation, and the median value of each respective variable.

7. The method of claim 1, wherein the determining, by the computer system, the plurality of statistical characteristics about the subset of variables in the data set based upon the number of observances of each respective variable of the subset of variables includes:
for each respective variable, determining a value of the number of observations of the variable at the lowest 25% of a scale from a minimum value to a maximum value;
for each respective variable, determining a value of the number of observations of the variable at the highest 25% of a scale from a minimum value to a maximum value.

8. The method of claim 1, wherein the determining, by the computer system, the plurality of statistical characteristics about the subset of variables in the data set based upon the number of observances of each respective variable of the subset of variables includes:
determining a number of non missing values of each respective variable; and
determining a number of unique values of each respective variable.

9. The method of claim 1, further comprising:
deleting at least one variable of the subset of variables;
generating a new data set with a second subset of variables from the set of variables, the second subset of variables including at least 450 variables and not including the deleted at least one variable;
accessing, by the computer system, the macro for determining a plurality of statistical characteristics about the second subset of variables in the new data set;
determining, by the computer system, the plurality of statistical characteristics about the second subset of variables in the new data set based upon a number of observances of each respective variable of the new subset of variables;
generating a second report of the determined plurality of statistical characteristics about the second subset, the second report including fields preconfigured to identify the determined plurality of statistical characteristics about the second subset per respective variable of the at least 450 variables; and
outputting the second report to the user device.

10. An apparatus comprising:
at least one processor; and
at least one memory having stored therein computer executable instructions, that when executed by the at least one processor, cause the apparatus to perform a method of:
generating a data set with a subset of variables from a set of variables, the set of variables representative of variables of data of customers associated with an entity, the subset of variables including at least 450 variables;
accessing a macro for determining a plurality of statistical characteristics about the subset of variables in the data set;
determining, by the computer system, the plurality of statistical characteristics about the subset of variables in the data set based upon a number of observances of each respective variable of the subset of variables;
generating a report of the determined plurality of statistical characteristics, the report including fields preconfigured to identify the determined plurality of statistical characteristics per respective variable of the at least 450 variables; and
outputting the report to a user device.

11. The apparatus of claim 10, wherein the determining the plurality of statistical characteristics about the subset of variables in the data set based upon the number of observances of each respective variable of the subset of variables includes:
determining a mean value of each respective variable;
determining a standard deviation of each respective variable;
determining a minimum value of each respective variable;
determining a median value of each respective variable; and
determining a maximum value of each respective variable.

12. The apparatus of claim 11, the generating the report of the determined plurality of statistical characteristics including:
generating a first column identifying each respective variable;
generating a second column identifying the mean value of each respective variable;
generating a third column identifying the standard deviation of each respective variable;
generating a fourth column identifying the minimum value of each respective variable;
generating a fifth column identifying the median value of each respective variable; and
generating a sixth column identifying the maximum value of each respective variable.

13. The apparatus of claim 12, wherein only non missing values of variables of the subset of variables are utilized for determining the mean value, the standard deviation, and the median value of each respective variable.

14. The apparatus of claim 10, wherein the determining, by the computer system, the plurality of statistical characteristics about the subset of variables in the data set based upon the number of observances of each respective variable of the subset of variables includes:
for each respective variable, determining a value of the number of observations of the variable at the lowest 25% of a scale from a minimum value to a maximum value;
for each respective variable, determining a value of the number of observations of the variable at the highest 25% of a scale from a minimum value to a maximum value.

15. The apparatus of claim 10, the computer executable instructions further causing the apparatus to perform a method of:
deleting at least one variable of the subset of variables;
generating a new data set with a second subset of variables from the set of variables, the second subset of variables including at least 450 variables and not including the deleted at least one variable;
accessing the macro for determining a plurality of statistical characteristics about the second subset of variables in the new data set;
determining the plurality of statistical characteristics about the second subset of variables in the new data set based upon a number of observances of each respective variable of the new subset of variables;
generating a second report of the determined plurality of statistical characteristics about the second subset, the second report including fields preconfigured to identify the determined plurality of statistical characteristics about the second subset per respective variable of the at least 450 variables; and
outputting the second report to the user device.

16. One or more computer-readable media storing computer-readable instructions that, when executed by at least one computer, cause the at least one computer to perform a method of:
generating a data set with a subset of variables from a set of variables, the set of variables representative of variables of data of customers associated with an entity, the subset of variables including at least 450 variables;
accessing a macro for determining a plurality of statistical characteristics about the subset of variables in the data set;
determining, by the computer system, the plurality of statistical characteristics about the subset of variables in the data set based upon a number of observances of each respective variable of the subset of variables;
generating a report of the determined plurality of statistical characteristics, the report including fields preconfigured to identify the determined plurality of statistical characteristics per respective variable of the at least 450 variables; and
outputting the report to a user device.

17. The one or more computer-readable media of claim 16, wherein the determining the plurality of statistical characteristics about the subset of variables in the data set based upon the number of observances of each respective variable of the subset of variables includes:
determining a mean value of each respective variable;
determining a standard deviation of each respective variable;
determining a minimum value of each respective variable;
determining a median value of each respective variable; and
determining a maximum value of each respective variable.

18. The one or more computer-readable media of claim 17, the generating the report of the determined plurality of statistical characteristics including:
generating a first column identifying each respective variable;
generating a second column identifying the mean value of each respective variable;
generating a third column identifying the standard deviation of each respective variable;
generating a fourth column identifying the minimum value of each respective variable;
generating a fifth column identifying the median value of each respective variable; and
generating a sixth column identifying the maximum value of each respective variable.

19. The one or more computer-readable media of claim 18, wherein only non missing values of variables of the subset of variables are utilized for determining the mean value, the standard deviation, and the median value of each respective variable.

20. The one or more computer-readable media of claim 16, the computer-readable instructions further causing the at leas tone computer to perform a method of:
deleting at least one variable of the subset of variables;
generating a new data set with a second subset of variables from the set of variables, the second subset of variables including at least 450 variables and not including the deleted at least one variable;
accessing the macro for determining a plurality of statistical characteristics about the second subset of variables in the new data set;
determining the plurality of statistical characteristics about the second subset of variables in the new data set based upon a number of observances of each respective variable of the new subset of variables;
generating a second report of the determined plurality of statistical characteristics about the second subset, the second report including fields preconfigured to identify the determined plurality of statistical characteristics about the second subset per respective variable of the at least 450 variables; and
outputting the second report to the user device.
